(19) United States
(12) Patent Application Publication
(10) Pub. No.: US 2026/0011759 A1
(43) Pub. Date: Jan. 8, 2026

(54) FLOW BATTERY BUBBLE DETECTION SYSTEM

(71) Applicant: CPC Corporation, Taiwan, Kaohsiung City (TW)

(72) Inventors: Hong-Yu Lin, Kaohsiung City (TW); Jui-Hsiung Huang, Kaohsiung City (TW); Yao-Ming Wang, Kaohsiung City (TW); Shang-Ching Chuang, Kaohsiung City (TW); Chen-Shun Chen, Kaohsiung City (TW)

(21) Appl. No.: 18/816,373

(22) Filed: Aug. 27, 2024

(30) Foreign Application Priority Data
Jul. 4, 2024 (TW) 113125184

(51) Int. Cl. H01M 8/0444; H01M 8/04746; H01M 8/04858; H01M 8/18

(52) U.S. Cl. CPC H01M 8/0444; H01M 8/04753; H01M 8/04873; H01M 8/188

(57) ABSTRACT

A flow battery bubble detection system includes a flow battery having a cathode and an anode circulation flow path, an electrochemical cell and an exchange membrane. A portion of the cathode or the anode circulation flow path is formed as a light-transmissible flow path section. A detection device includes a light source, a receiving unit and a detection unit. The light source and receiving unit are connected to the detection unit and respectively arranged on opposite sides of the light-transmissible flow path section so that a detection light of a single wavelength emitted from the light source travels through the light-transmissible flow path section and is received by the receiving unit. The receiving unit outputs a detection voltage signal to the detection unit corresponding to the received detection light. The detection unit detects bubbles in the electrolyte flowing through the light-transmissible flow path section based on the detection voltage signal.

### CROSS-REFERENCE TO RELATED APPLICATIONS

This disclosure claims priority under 35 U.S.C. § 119 to Taiwan Patent Application No. 113125184, titled “FLOW BATTERY BUBBLE DETECTION SYSTEM,” filed on Jul. 4, 2024, the disclosure of which is incorporated herein by reference in its entirety.

### FIELD OF THE INVENTION

The present invention relates to a flow battery bubble detection system and more particularly relates to a flow battery bubble detection system using optical methods for detecting bubbles in flow batteries.

### BACKGROUND OF THE INVENTION

The structure of a flow battery usually includes two flow path systems and an exchange membrane, wherein the two flow path systems are separated by the exchange membrane, and electrolytes circulate in the respective flow path systems.

Gas may be generated to form bubbles in the electrolyte during the operation of the flow battery. Accordingly, the presence of bubbles may cause misjudgment of the battery's charging status under which the continued operations of the flow battery in this situation may eventually lead to battery damage.

### SUMMARY OF THE INVENTION

Therefore, one objective of present invention is to provide a flow battery system which is able to detect the presence of bubbles in the electrolyte.

In order to overcome the technical problems in prior art, the present invention provides a flow battery bubble detection system, comprising a flow battery comprising a cathode circulation flow path, an anode circulation flow path, an electrochemical cell and an exchange membrane, the exchange membrane being arranged in the electrochemical cell in a manner that the electrochemical cell is separated into a cathode area and an anode area, the cathode circulation flow path communicating with the cathode area while a cathode electrolyte circulates in the cathode circulation flow path, and the anode circulation flow path communicating with the anode area while an anode electrolyte circulates in the anode circulation flow path, wherein a portion of the cathode circulation flow path or the anode circulation flow path is formed as a light-transmissible flow path section; and a detection device comprising a light source, a receiving unit and a detection unit, wherein the light source and the receiving unit are connected to the detection unit and are respectively arranged on opposite sides of the light-transmissible flow path section so that a detection light of a single wavelength emitted from the light source travels through the light-transmissible flow path section and is received by the receiving unit, the receiving unit outputs a detection voltage signal to the detection unit corresponding to the received detection light, and the detection unit detects the presence of bubbles in the cathode electrolyte or the anode electrolyte flowing through the light-transmissible flow path section based on the detection voltage signal.

In one embodiment of the present invention, the flow battery bubble detection system is provided, wherein the light source and the receiving unit are arranged to be opposite to each other in a diameter direction of the light-transmissible flow path section.

In one embodiment of the present invention, the flow battery bubble detection system is provided, wherein the cathode circulation flow path and anode circulation flow path are both formed with the light-transmissible flow path section for detection of both the cathode circulation flow path and the anode circulation flow path.

In one embodiment of the present invention, the flow battery bubble detection system is provided further comprising an alarm device, which is connected to the detection unit and emits an alarm signal when the presence of bubbles is detected by the detection unit.

In one embodiment of the present invention, the flow battery bubble detection system is provided further comprising a voltage reduction device which is connected to the detection unit and the flow battery and is instructed to reduce charging voltage of the flow battery when the presence of bubbles is detected by the detection unit.

In one embodiment of the present invention, the flow battery bubble detection system is provided further comprising a flow rate increasing device which is connected to the detection unit and the flow battery and increases the flow rate of the electrolyte in the flow battery when the presence of bubbles is detected by the detection unit.

In one embodiment of the present invention, the flow battery bubble detection system is provided further comprising a wireless connection device which is connected to the alarm device and the alarm device is wirelessly connected with a cloud device through the wireless connection device.

With the technical means adopted by the present invention, bubbles in the flow battery can be detected optically to avoid corrosion of detector caused by direct contact with acid or alkaline electrolytes, thereby providing a flow battery system with stability and safety.

### BRIEF DESCRIPTION OF THE DRAWINGS

FIG. 1 is a schematic drawing illustrating a flow battery bubble detection system according to one embodiment of the present invention;

FIG. 2 is a schematic drawing illustrating a flow battery bubble detection system according to one embodiment of the present invention;

FIC 3 is a schematic drawing illustrating a flow battery bubble detection system according to one embodiment of the present invention.

FIG. 4 is a schematic drawing illustrating a flow battery bubble detection system according to one embodiment of the present invention; and

FIG. 5 is a schematic drawing illustrating a flow battery bubble detection system according to one embodiment of the present invention.

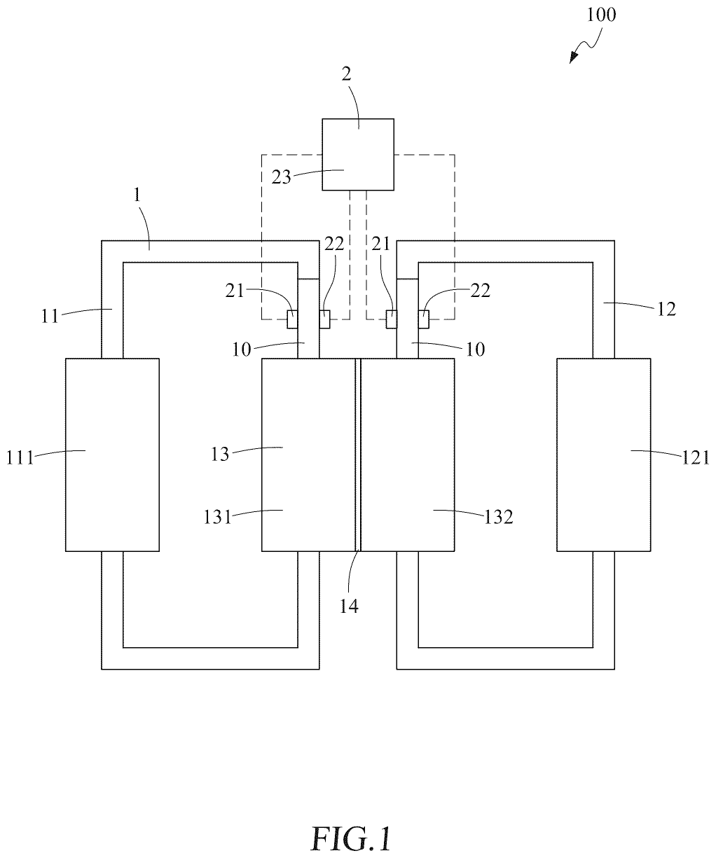

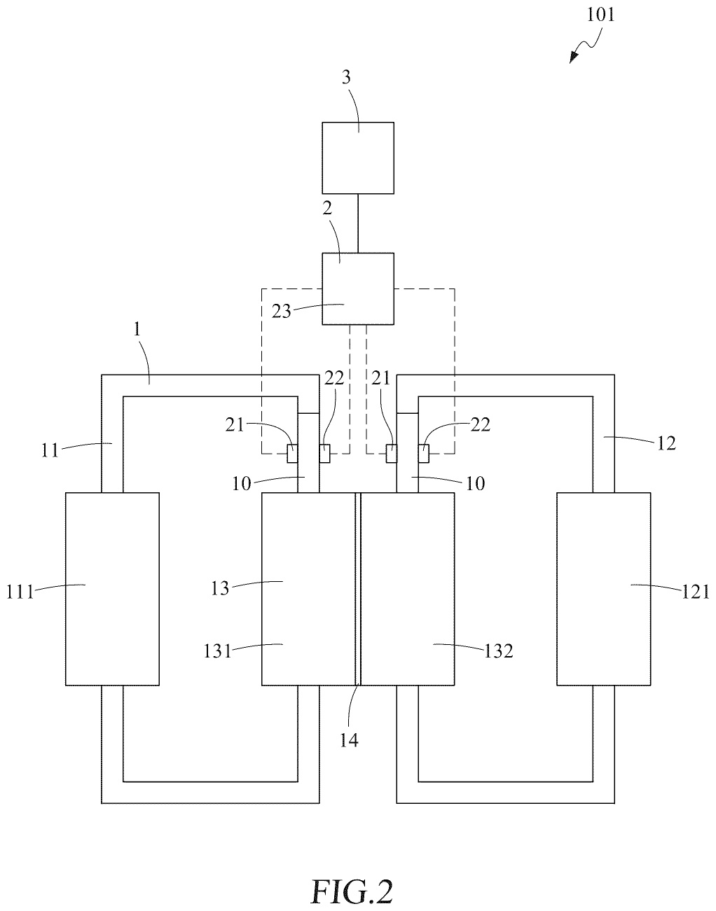

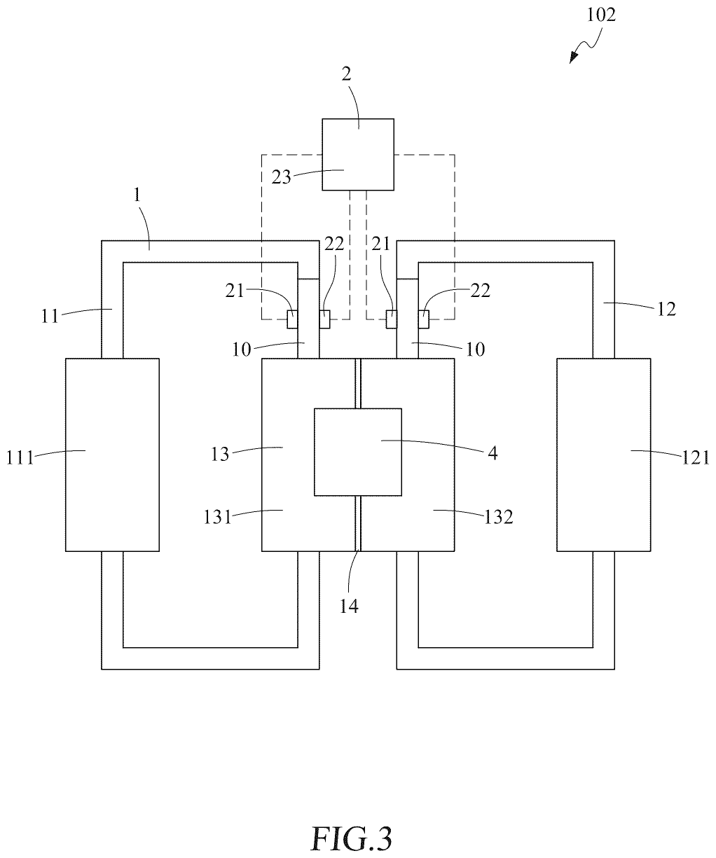

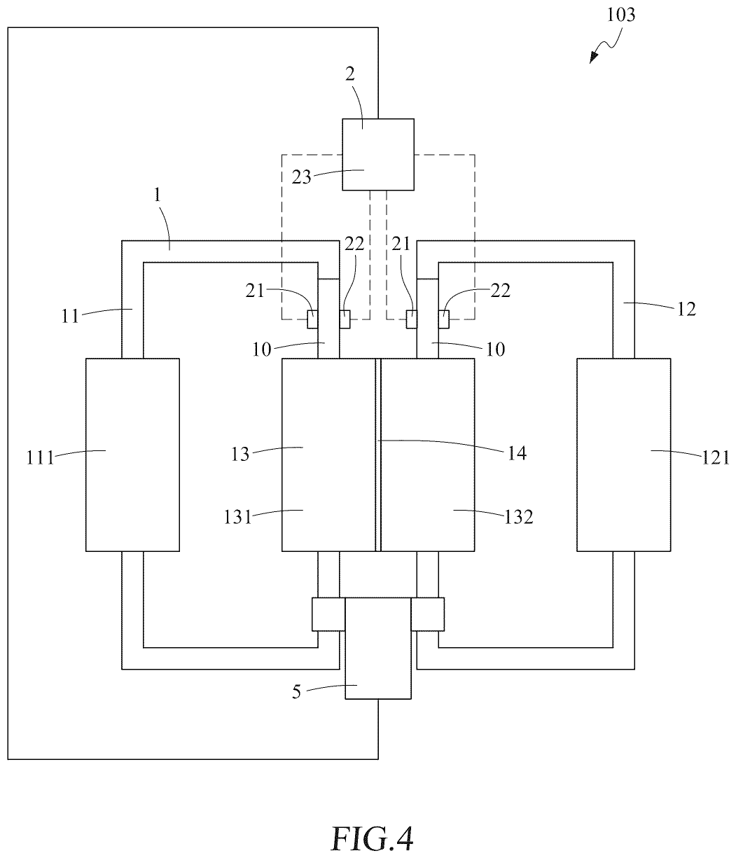

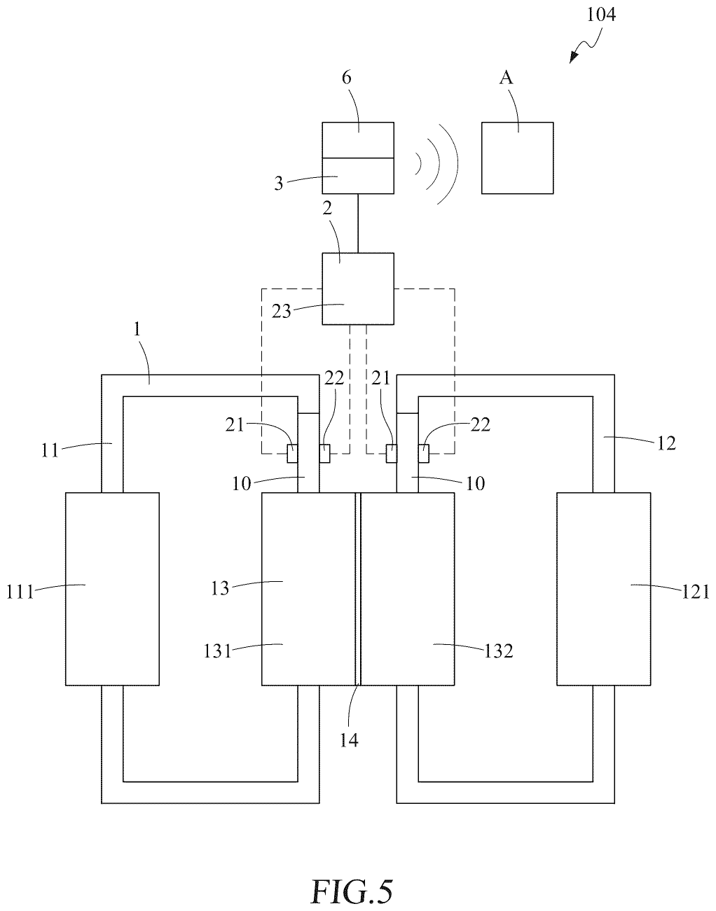

### DETAILED DESCRIPTION OF THE PREFERRED EMBODIMENTS

The preferred embodiments of the present invention are described in detail below. The description is used for explaining the embodiments of the present invention only, but not for limiting the scope of the claims.

According to one embodiment of the present invention, a flow battery bubble detection system 100 comprises a flow battery 1 comprising a cathode circulation flow path 11, an anode circulation flow path 12, an electrochemical cell 13 and an exchange membrane 14, the exchange membrane 14 being arranged in the electrochemical cell 13 in a manner that the electrochemical cell 13 is separated into a cathode area 131 and an anode area 132, the cathode circulation flow path 11 communicating with the cathode area 131 while a cathode electrolyte 111 circulates in the cathode circulation flow path 11, and the anode circulation flow path 12 communicating with the anode area 132 while an anode electrolyte 121 circulates in the anode circulation flow path 12.

A portion of the cathode circulation flow path 11 or the anode circulation flow path 12 is formed as a light-transmissible flow path section 10.

By forming the light-transmissible flow path section 10 in the flow path, light can pass through the flow path and the electrolyte flowing therein.

The flow battery bubble detection system 100 further comprises a detection device 2 comprising a light source 21, a receiving unit 22 and a detection unit 23, wherein the light source 21 and the receiving unit 22 are connected to the detection unit 23 and are respectively arranged on opposite sides of the light-transmissible flow path section 10 so that a detection light of a single wavelength emitted from the light source 21 travels through the light-transmissible flow path section 10 and is received by the receiving unit 22, the receiving unit 23 outputs a detection voltage signal to the detection unit 23 corresponding to the received detection light, and the detection unit 23 detects the presence of bubbles in the cathode electrolyte 111 or the anode electrolyte 121 flowing through the light-transmissible flow path section 10 based on the detection voltage signal.

By respectively arranging the light source 21 and the receiving unit 22 on opposite sides of the light-transmissible flow path section 10, the light emitted by the light source 21 can pass through the light-transmissible flow path section 10 and the electrolyte therein and be received by the receiving unit 22, thereby avoiding corrosion of the light source 21 and the receiving unit 22 caused by direct contact with the acidic electrolyte or alkaline electrolyte.

When bubbles appear in the electrolyte in the light-transmissible flow path section 10, the light passing through the bubbles in the electrolyte will cause the receiving unit 22 to output higher detection voltage compared to the detection voltage output by the receiving unit 22 when the light passes through the electrolyte, thereby forming a surge.

Therefore, the detection unit 23 determines the presence of bubbles in the electrolyte when a surge occurs in the detection voltage signal, allowing the user to determine whether further processing is required.

Furthermore, the detection unit 23 can determine that the circulation flow path is broken and leaking when the number of surges in a certain period of time exceeds a predetermined number, thereby improving the resolution of recognizing the presence of bubbles in the electrolyte.

In the flow battery bubble detection system 100 according to one embodiment of the present invention, the light source 21 and the receiving unit 22 are arranged to be opposite to each other in a diameter direction of the light-transmissible flow path section 10.

By such an arrangement, the path of light from the light source 21 through the light-transmissible flow path section 10 to the receiving unit 22 can be the shortest distance so that the detection accuracy can be improved.

In the flow battery bubble detection system 100 according to one embodiment of the present invention, the cathode circulation flow path 11 and anode circulation flow path 12 of the flow battery 1 are both formed with the light-transmissible flow path section 10 for detection of both the electrolyte 111, 121 flowing through the cathode circulation flow path 11 and the anode circulation flow path 12.

By forming the light-transmissible flow path section 10 in both the cathode circulation flow path 11 and the anode circulation flow path 12, light emitted from the light source 21 can pass through the cathode circulation flow path 11 and the anode circulation flow path 12 to detect bubbles in these two flow paths.

Furthermore, two sets of the light sources 21 and the receiving units 22 may be used, wherein a single circulation flow path is detected by using a single set of the light sources 21 and the receiving units 22 to improve the detection accuracy.

In the flow battery bubble detection system 101 according to another embodiment of the present invention, the flow battery bubble detection system 101 further comprises an alarm device 3, which is connected to the detection unit 23 and emits an alarm signal when the presence of bubbles is detected by the detection unit 23.

A In the flow battery bubble detection system 102 according to another embodiment of the present invention, the flow battery bubble detection system 102 further comprises a voltage reduction device 4 which is connected to the detection unit 23 and the flow battery 1 and is instructed to reduce charging voltage of the flow battery 1 when the presence of bubbles is detected by the detection unit 23.

This allows the voltage reduction device 4 reduces charging voltage of the flow battery 1 through the voltage reducing device 4 when the detection unit 23 determines the presence of bubbles in the electrolyte, to avoid continued gas generation which may cause further damage to the flow battery 1.

In the flow battery bubble detection system 103 according to another embodiment of the present invention, the flow battery bubble detection system 103 further comprises a flow rate increasing device 5 which is connected to the detection unit 23 and the flow battery 1 and increases the flow rate of the electrolyte in the flow battery 1 when the presence of bubbles is detected by the detection unit 23.

This allows the flow rate increasing device 5 increases flow rate of the electrolyte in the flow battery 1 through the flow rate increasing device 5 when the detection unit 23 determines the presence of bubbles in the electrolyte, to avoid continued gas generation which may cause further damage to the flow battery 1.

In the flow battery bubble detection system 104 according to another embodiment of the present invention, the flow battery bubble detection system 104 further comprises a wireless connection device 6 which is connected to the alarm device 3 and the alarm device 3 is wirelessly connected with a cloud device A through the wireless connection device 6.

This allows the alarm signal emitted by the alarm device 3 is sent wirelessly to the cloud device A, such as a smart phone, through the wireless connection device 6 to notify the smart phone user of the status of the flow battery 1 and urge him to take action to avoid continued gas generation which may cause further damage to the flow battery 1.

In the flow battery bubble detection system according to the flow battery bubble detection system of the present invention, bubbles in the flow battery can be optically detected while corrosion of detector caused by direct contact with acid and alkaline electrolytes can be avoided to provide a flow battery system with stability and safety.

The above description should be considered as only the discussion of the preferred embodiments of the present invention. However, a person having ordinary skill in the art may make various modifications without deviating from the present invention. Those modifications still fall within the scope of the present invention.

What is claimed is:

1. A flow battery bubble detection system, comprising:
a flow battery comprising a cathode circulation flow path, an anode circulation flow path, an electrochemical cell and an exchange membrane, the exchange membrane being arranged in the electrochemical cell in a manner that the electrochemical cell is separated into a cathode area and an anode area, the cathode circulation flow path communicating with the cathode area while a cathode electrolyte circulates in the cathode circulation flow path, and the anode circulation flow path communicating with the anode area while an anode electrolyte circulates in the anode circulation flow path, wherein a portion of the cathode circulation flow path or the anode circulation flow path is formed as a light-transmissible flow path section; and
a detection device comprising a light source, a receiving unit and a detection unit, wherein the light source and the receiving unit are connected to the detection unit and are respectively arranged on opposite sides of the light-transmissible flow path section so that a detection light of a single wavelength emitted from the light source travels through the light-transmissible flow path section and is received by the receiving unit, the receiving unit outputs a detection voltage signal to the detection unit corresponding to the received detection light, and the detection unit detects the presence of bubbles in the cathode electrolyte or the anode electrolyte flowing through the light-transmissible flow path section based on the detection voltage signal.

2. The flow battery bubble detection system as claimed in claim 1, wherein the light source and the receiving unit are arranged to be opposite to each other in a diameter direction of the light-transmissible flow path section.

3. The flow battery bubble detection system as claimed in claim 1, wherein the cathode circulation flow path and anode circulation flow path are both formed with the light-transmissible flow path section for detection of both the cathode circulation flow path and the anode circulation flow path.

4. The flow battery bubble detection system as claimed in claim 1, further comprising an alarm device, which is connected to the detection unit and emits an alarm signal when the presence of bubbles is detected by the detection unit.

5. The flow battery bubble detection system as claimed in claim 1, further comprising a voltage reduction device which is connected to the detection unit and the flow battery and is instructed to reduce charging voltage of the flow battery when the presence of bubbles is detected by the detection unit.

6. The flow battery bubble detection system as claimed in claim 1, further comprising a flow rate increasing device which is connected to the detection unit and the flow battery and increases the flow rate of the electrolyte in the flow battery when the presence of bubbles is detected by the detection unit.

7. The flow battery bubble detection system as claimed in claim 4, further comprising a wireless connection device which is connected to the alarm device and the alarm device is wirelessly connected with a cloud device through the wireless connection device.
